(19) United States
(12) Patent Application Publication
(10) Pub. No.: US 2009/0115343 A1
(43) Pub. Date: May 7, 2009

(54) LED Power Regulator with High-Speed LED Switching

(76) Inventor: Brian Matthew King, Lewisville, TX (US)

Correspondence Address: TEXAS INSTRUMENTS INCORPORATED, P O BOX 655474, M/S 3999, DALLAS, TX, 75265, US

(21) Appl. No.: 11/935,748

(22) Filed: Nov. 6, 2007

(51) Int. Cl. H05B 41/36

(52) U.S. Cl. 315/291

(57) ABSTRACT

One embodiment of the invention includes a power regulator system. The system comprises at least one power switch configured to repeatedly couple an inductor to an input voltage to regulate a current flow through the inductor. The system also comprises a light-emitting diode (LED) configured to provide illumination based on an amount of the current flow through the inductor. The system further comprises an output switch configured to couple and decouple the LED from the current flow through the inductor in response to an activation signal.

### TECHNICAL FIELD

This invention relates to electronic circuits, and more specifically to a light-emitting diode (LED) power regulator with high-speed LED switching.

### BACKGROUND

There is an ever increasing demand for electronic devices to operate with increased efficiency and reduced power to accommodate improved performance. One such example of power conservation is the use of light-emitting diodes (LEDs) instead of incandescent bulbs for use in illumination. One such example of an LED application is in digital light projection (DLP), such as for televisions and projectors. As an example, some DLP televisions and projectors substitute a high-intensity discharge (HID) bulb and color-wheel arrangement with much more energy efficient red, green, and blue LED clusters. Light from the LED clusters can thus be directed to specific pixels in a given combination to provide the desired colors on the television or projection screen. As a result, the LED operated television or projector can operate with significantly less power, and can also benefit from having a longer operating life due to the significantly greater operating longevity of LEDs relative to incandescent bulbs.

LEDs typically require a driving current to provide illumination. Thus, LED clusters may include one or more current regulators to maintain a sufficient current flow to provide adequate illumination. As a result, an LED cluster may include a regulated supply voltage to provide the current flow through the LEDs. The current through the LEDs can be set to vary the intensity of the LEDs, such that different shades of different colors can be generated from the red, green, and blue LEDs. In addition, some LEDs may be deactivated to provide no illumination, thus providing greater color control of the television or projection screen. Typical DLP systems that use LEDs implement linear regulators to provide sharper screen images and faster update times, particularly with regard to activation and deactivation of LEDs. However, the use of linear regulators with the LEDs, although still more energy efficient than HID bulbs, are less efficient than switching regulators. Fixed-frequency switching regulators used as LED drivers provide excellent efficiency, by may suffer from slow response times.

### SUMMARY

One embodiment of the invention includes a power regulator system. The system comprises at least one power switch configured to repeatedly couple an inductor to an input voltage to regulate a current flow through the inductor. The system also comprises a light-emitting diode (LED) configured to provide illumination based on an amount of the current flow through the inductor. The system further comprises an output switch configured to couple and decouple the LED from the current flow through the inductor in response to an activation signal.

Another embodiment of the invention includes a method for controlling power to an LED. The method comprises repeatedly activating at least one power switch to provide a current flow through an inductor from an input voltage and activating an output switch to couple the current flow through the inductor to the LED to illuminate the LED. The method also comprises deactivating the output switch to decouple the LED from the current flow through the inductor to deactivate the LED.

Another embodiment of the invention includes a power regulator. The power regulator comprises means for repeatedly coupling an inductor to an input voltage to regulate a current flow through the inductor and means for coupling and decoupling a light-emitting diode (LED) from the current flow through the inductor in response to an activation signal. The system also comprises means for dissipating the current flow through the inductor upon decoupling the LED from the current flow through the inductor.

### BRIEF DESCRIPTION OF THE DRAWINGS

FIG. 1 illustrates an example of a power regulator system in accordance with an aspect of the invention.

FIG. 2 illustrates an example of a digital light projection (DLP) system in accordance with an aspect of the invention.

FIG. 3 illustrates an example of a method for controlling power to a light-emitting diode (LED) in accordance with an aspect of the invention.

### DETAILED DESCRIPTION

The invention relates to electronic circuits, and more specifically to a light-emitting diode (LED) power regulator with high-speed LED switching. A power regulator provides a regulated current flow through an inductor based on at least one power switch. The power regulator can be a buck converter, and the at least one power switch can include a high-side switch and can also include a low-side power switch and/or a low-side freewheeling diode. The current flow through the inductor can be provided to one or more LEDs via an output switch. The output switch is activated by an activation signal, such that all of the regulated inductor current is provided to the one or more LEDs. The output switch can be deactivated to remove the current from the LEDs, thus deactivating the LEDs. The current through the inductor can thus be redirected through a feedback diode that biases the current flow through the inductor back to the input voltage. The inductor energy is thus recycled back to the input, and the LED current begins each new activation cycle with a known current magnitude of zero amps. As a result, the one or more LEDs can be efficiently current regulated and can be switched at very high-speeds.

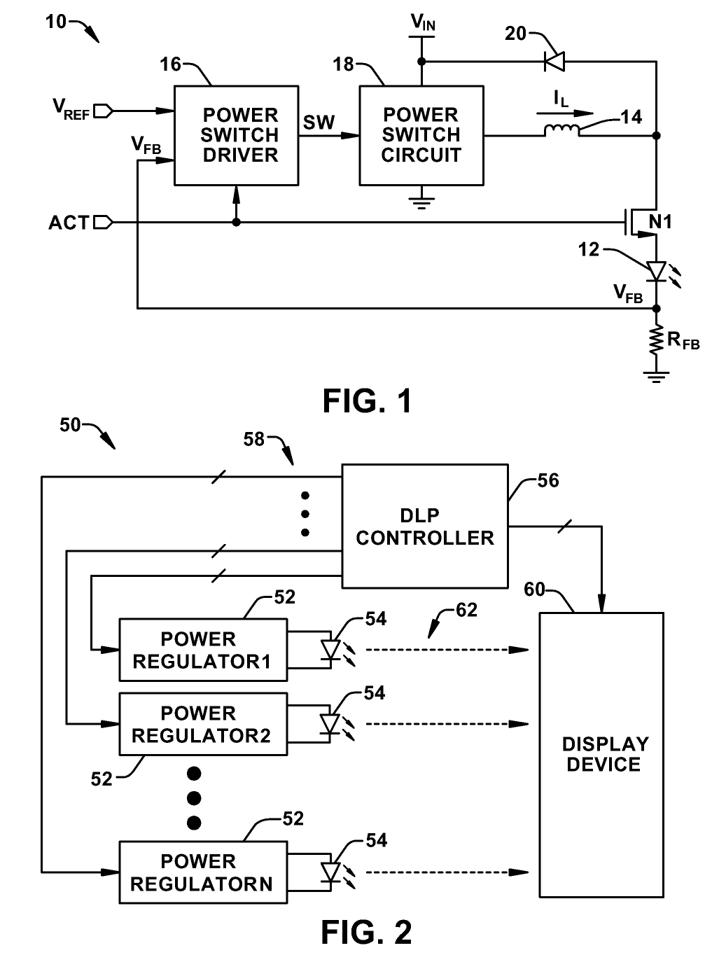

FIG. 1 illustrates an example of a power regulator system 10 in accordance with an aspect of the invention. The power regulator system 10 is demonstrated in the example of FIG. 1 as a buck converter that is configured to provide power to an LED 12. Although the example of FIG. 1 demonstrates only a single LED 12, it is to be understood that the power regulator system 10 can be configured to provide power to multiple LEDs that are arranged in parallel or in series. Thus, the power regulator system 10 can be included in any of a variety of applications that implements power regulation to control an intensity of illumination of LEDs, such as a digital light projection (DLP) system.

The power that is provided to the LED 12 by the power regulator system 10 is a regulated current flow I_{L} that flows through the LED 12. The magnitude of the current I_{L} can be set based on pulse-width modulation (PWM) to generate the current I_{L} through an inductor 14. As a result, the current I_{L} can be generated in a power efficient manner. In addition, because the PWM can be hysteretic, the current I_{L} can be adjusted to rapidly vary the intensity of the LED 12, thus providing a faster response time for the illumination of the LED 12 over typical fixed-frequency switching regulation of power through an LED. As a result, the LED 12 can be activated and deactivated (i.e., power removed from the LED 12) at very high frequencies to exhibit even greater control of the illumination of the LED 12.

The power regulator system 10 includes a power switch driver 16 that receives a reference voltage V_{REF}. The reference voltage V_{REF} can be a voltage potential corresponding to a desired current flow through the LED 12 to control the illumination intensity of the LED 12. The reference voltage V_{REF} can be compared with a feedback voltage V_{FB} corresponding to an actual current flow through the LED 12, such that the current flow through the LED 12 can be regulated to be substantially equal to the desired current flow. As an example, the power switch driver 16 can include an error amplifier (not shown) configured to generate an error signal corresponding to a difference between the reference voltage V_{REF} and the feedback voltage V_{FB}. In response, the power switch driver 16 generates a switching signal SW that can be a PWM signal having an on-state and an off-state.

The switching signal SW is provided to a power switch circuit 18. The power switch circuit 18 is configured to provide the current I_{L} through the inductor 14 via an input voltage V_{IN}. As an example, the power switch circuit 18 can include a high-side switch and a low-side switch that are mutually exclusively activated by the switching signal SW. Thus, the high-side switch couples the inductor 14 to the input voltage V_{IN} to provide the current I_{L} based on one state of the switching signal SW, and the low-side switch couples the inductor 14 to ground to draw current from ground to maintain the current I_{L} based on the other state of the switching signal SW. As another example, the power switch circuit 18 can include a high-side switch and a freewheeling diode having an anode coupled to ground and a cathode coupled to the inductor 14. Thus, current flows from ground to the inductor 14 upon the inductor 14 being decoupled from the input voltage V_{IN} based on the switching signal SW. As a result, the current I_{L} through the inductor 14 is efficiently generated.

As described above, the switching signal SW can be a PWM signal, and the power switch driver 16 can operate in a hysteretic manner in generating the switching signal SW. As a result, the pulse-width of the switching signal SW can be as long or as short as necessary to achieve a steady state of operation. In other words, the switching signal SW may not have a fixed-frequency, such that the sum of the on-time and the off-time may not be equal from one switching period to the next. As a result, the magnitude of the current I_{L} can have a substantially higher slew-rate than if the switching signal SW had a fixed-frequency. As a result, the current I_{L} can increase more rapidly in response to activation of the power regulator system 10 or an increase in the reference voltage V_{REF}. Likewise, the current I_{L} can decrease more rapidly in response to a decrease in the reference voltage V_{REF} or deactivation of the LED 12, as described below.

The power regulator system 10 includes an output switch N1, demonstrated in the example of FIG. 1 as an N-type field effect transistor (FET). The output switch N1 is controlled by an activation signal ACT and is configured to respectively couple and decouple the current I_{L} to and from the LED 12. Therefore, during typical operation of the power regulator system 10, the activation signal ACT is asserted (i.e., logic-high) to provide the LED 12 with the regulated current I_{L} to illuminate the LED 12. The current I_{L} thus flows through the LED 12 and through a feedback resistor R_{FB} to ground. The feedback resistor R_{FB} has a resistance magnitude that sets the magnitude of the feedback voltage V_{FB} between the cathode of the LED 12 and the feedback resistor R_{FB} based on the current through the LED 12. Therefore, the magnitude of the feedback voltage V_{FB} corresponds to the current flow through the LED 12.

The output switch N1 can be deactivated to decouple the LED 12 from the current I_{L} when the activation signal ACT is deasserted (i.e., logic-low). Therefore, the LED 12 is immediately deactivated, and the feedback voltage V_{FB} becomes approximately zero. However, upon decoupling the LED 12 from the current I_{L}, the inductor 14 may still have stored magnetic energy based on the current I_{L}. Thus, the power regulator system 10 includes a feedback diode 20 that interconnects the output of the inductor 14 to the input voltage V_{IN}. Specifically, upon the deactivation of the output switch N1, the magnetic energy in the inductor 14 begins to discharge, thus increasing the voltage at the output of the inductor 14 to a magnitude greater than the input voltage V_{IN}. Therefore, the feedback diode 20 provides a current path for the current I_{L} to continue to flow as the magnetic energy in the inductor 14 discharges. As a result, energy that is stored in the inductor is recaptured at the input source.

As demonstrated in the example of FIG. 1, the activation signal ACT is also provided to the power switch driver 16. Therefore, upon deasserting the activation signal ACT to decouple the LED 12 from the current I_{L}, the power switch driver 16 can provide the switching signal SW to decouple the inductor 14 from the input voltage V_{IN}. Providing the activation signal ACT to the power switch driver 16 thus prevents the substantial difference between the reference voltage V_{REF} and the zero magnitude feedback voltage V_{FB} from forcing the power switch driver 16 to otherwise couple the inductor 14 to the input voltage V_{IN}, such as occurring in typical operation. In addition, as an example, the source of the input voltage V_{IN} can include a bank of one or more capacitors (not shown) interconnecting the input voltage V_{IN} and ground that can be charged by the dissipating current I_{L}. As a result, because the inductor 14 is decoupled from the input voltage V_{IN}, and because current I_{L} has a path to ground via the capacitors, the magnetic energy stored in the inductor 14 and the corresponding current I_{L} can dissipate to a magnitude of substantially zero. Upon reactivating the output switch N1, the inductor 14 can be recoupled to the input voltage V_{IN} to begin increasing the current I_{L}, thus illuminating the LED 12 again.

Due to the activation and deactivation of the LED 12 based on the digital control of the output switch N1 and the absence of a limited bandwidth feedback loop, the LED 12 can be activated and deactivated substantially more quickly than with a fixed-frequency switching regulator. In addition, because of the PWM control of the generation of the current I_{L}, the power regulator system 10 thus regulates power more efficiently than a linear regulator. Furthermore, the feedback diode 20 provides the power regulator system 10 with the capability of combining the high-speed activation and deactivation of the LED 12 with the efficient power regulation of the PWM control in generating the current I_{L} through the inductor 14.

It is to be understood that the power regulation system 10 is not limited to the example of FIG. 1. As an example, the power regulation system 10 is illustrated simplistically, such that there can be a variety of additional components that are not illustrated in the example of FIG. 1. As another example, the feedback voltage V_{FB} corresponding to the current flow through the LED 12 can be ascertained in a number of ways, as opposed to implementing the resistor R_{FB} as a sense resistor between the LED 12 and ground. Furthermore, it is also to be understood that the feedback current path of the current I_{L} is not limited to the feedback diode 20, but that any of a variety of other circuit devices, such as a transistor or other type of switch, can be implemented instead. Accordingly, the power regulation system 10 can be configured in any of a variety of ways.

FIG. 2 illustrates an example of a DLP system 50 in accordance with an aspect of the invention. The DLP system 50 can be included as part of a digital video display, such as a DLP television or a DLP projector. The DLP system 50 includes a plurality N of power regulators 52, each being configured to regulate power to a respective LED 54, where N is a positive integer. Each of the power regulators 52 can be configured substantially similar to the power regulation system 10 in the example of FIG. 1, with the respective LEDs 54 corresponding to the LED 12 in the example of FIG. 1. The LEDs 54 can be separately colored LEDs, such as red, green, and blue, and each LED 54 can be either an individual LED or can represent an LED cluster.

The DLP system 50 includes a DLP controller 56 that is programmed to assemble DLP images. As an example, the DLP controller 56 can include a signal processor configured to process a broadband video signal, such as a high-definition cable or satellite signal. The DLP controller 56 provides control signals 58 to each of the power regulators 52. Each of the control signals 58 can include a reference voltage, such as the reference voltage V_{REF} in the example of FIG. 1, as well as an activation signal ACT, that each correspond to the respective one of the power regulators 52. As a result, each of the LEDs 54 can be provided with an individually regulated current to control an amount of illumination intensity, and each of the LEDs 54 can be individually activated and deactivated at high-speed.

The DLP system 50 also includes a display device 60 that is configured to manipulate the illumination of the LEDs 54 for the display of the DLP images in response to a control signal CTRL from the DLP controller 56. Specifically, each of the LEDs 54 provides illumination, demonstrated at 62 in the example of FIG. 2, to the display device 60. The display device 60 can include a large plurality (e.g., one million or more) of configurable mirrors that direct the LED illumination 62 to individual pixels on a display screen of the respective television or projector. Therefore, the control signal CTRL provides commands to the display device 60 to control the mirrors for the direction of the LED illumination 62. Because the DLP controller 56 also controls the illumination intensity and activation/deactivation of each of the LEDs 54 via the power regulators 52, the DLP controller 56 can assemble the DLP images on the display screen of the television or projector. Furthermore, because the power regulators 52 are energy efficient, have high slew-rates, and can activate and deactivate the LEDs 54 at high-speeds, the DLP television or projector can be very energy efficient and can have rapid image updates for a clearer, sharper picture.

It is to be understood that the DLP system 50 is not limited to the example of FIG. 2. Specifically, the example of FIG. 2 is described very simplistically, and thus many devices that are included for the operation of a DLP system have been omitted for the sake of brevity. Furthermore, use in a DLP system such as the DLP system 50 in the example of FIG. 2 is but one example of the uses of the power regulator system 10 in the example of FIG. 1. Thus, it is to be understood that the power regulator system 10 in the example of FIG. 1 can be implemented in any of a variety of applications that may require energy efficient, high slew-rate control of one or more LEDs.

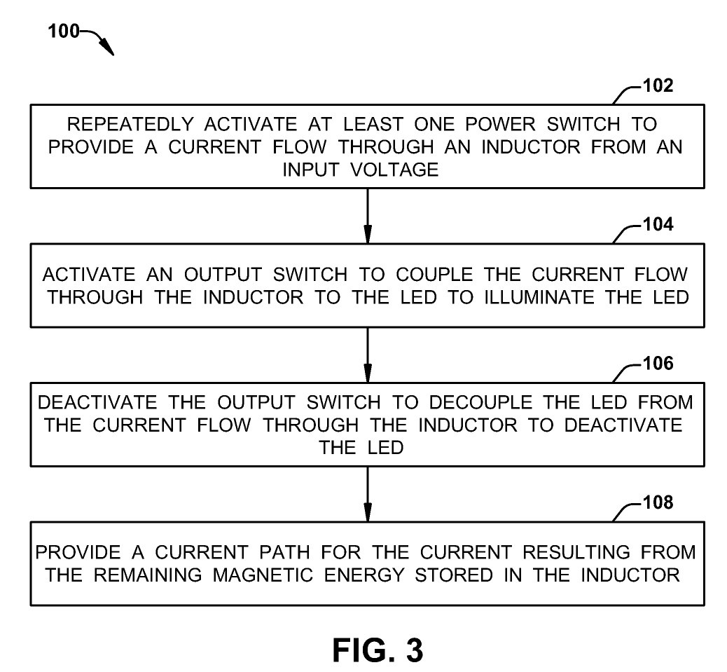

In view of the foregoing structural and functional features described above, certain methods will be better appreciated with reference to FIG. 3. It is to be understood and appreciated that the illustrated actions, in other embodiments, may occur in different orders and/or concurrently with other actions. Moreover, not all illustrated features may be required to implement a method.

FIG. 3 illustrates an example of a method 100 for controlling power to a LED in accordance with an aspect of the invention. At 102, at least one power switch is repeatedly activated to provide a current flow through an inductor from an input voltage. The repeated activation can be based on hysteretic pulse-width modulation (PWM), as opposed to fixed-frequency PWM, to achieve a greater slew-rate for the current flow. The hysteretic PWM can result from a comparison of a feedback voltage corresponding to a current flow through the LED with a reference voltage corresponding to a desired illumination intensity of the LED. The at least one output switch can be a high-side and low-side switch that are alternately activated, or can be a high-side switch and a freewheeling diode. At 104, an output switch is activated to couple the current flow through the inductor to the LED to illuminate the LED. Such can occur during a steady-state operation of the power regulator that provides the current to the LED. The output switch can be activated by a logic state of an activation signal.

At 106, the output switch is deactivated to decouple the LED from the current flow through the inductor to deactivate the LED. The output switch can be deactivated based on the other logic state of the activation signal. The activation signal can also be provided to prevent the coupling of the inductor to the input voltage. The LED can thus be digitally activated and deactivated at high-speed. Such high-speed activation and deactivation can contribute to faster screen updates in a DLP system that implements a plurality of power regulated LEDs. At 108, a current path for the current resulting from the remaining magnetic energy stored in the inductor is provided. The current path can be through a feedback diode that interconnects the output of the inductor to the input voltage. Thus, the LED can be rapidly deactivated while recapturing the magnetic energy stored in the inductor.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A power regulator system comprising:
at least one power switch configured to repeatedly couple an inductor to an input voltage to regulate a current flow through the inductor;
a light-emitting diode (LED) configured to provide illumination based on an amount of the current flow through the inductor; and
an output switch configured to couple and decouple the LED from the current flow through the inductor in response to an activation signal.

2. The system of claim 1, further comprising a diode interconnecting an output of the inductor and the input voltage, the diode being configured to bias the current flow through the inductor to the input voltage upon the output switch decoupling the LED from the current flow through the inductor.

3. The system of claim 1, wherein the power regulator system is a buck regulator system.

4. The system of claim 1, wherein the at least one power switch comprises a high-side power switch and a low-side power switch.

5. The system of claim 1, wherein the at least one power switch comprises a high-side power switch and a diode configured to provide the current flow through the inductor from ground upon the high-side switch being deactivated.

6. The system of claim 1, further comprising a switch driver configured to provide at least one respective activation signal to the at least one switch.

7. The system of claim 6, wherein the switch driver is configured as a hysteretic pulse-width modulation (PWM) switch driver.

8. The system of claim 6, wherein the switch driver is further configured to provide the at least one respective activation signal in response to a feedback voltage associated with a current flow through the LED.

9. A digital light projector (DLP) comprising the system of claim 1.

10. A method for controlling power to a light-emitting diode (LED), the method comprising:
repeatedly activating at least one power switch to provide a current flow through an inductor from an input voltage;
activating an output switch to couple the current flow through the inductor to the LED to illuminate the LED; and
deactivating the output switch to decouple the LED from the current flow through the inductor to deactivate the LED.

11. The method of claim 10, further comprising feeding back the current flow through the inductor through a feedback diode to the input voltage upon deactivating the output switch.

12. The method of claim 10, further comprising controlling illumination of the LED based on an amount of the current flow through the inductor.

13. The method of claim 10, wherein repeatedly activating the at least one power switch comprises alternately activating a high-side power switch and a low-side power switch to provide a current flow through an inductor from an input voltage.

14. The method of claim 10, wherein repeatedly activating the at least one power switch comprises alternately activating a high-side power switch and biasing a low-side diode to provide a current flow through an inductor from an input voltage.

15. The method of claim 10, further comprising regulating the current flow through the inductor based on a feedback voltage associated with a current flow through the LED.

16. The system of claim 10, wherein repeatedly activating the at least one power switch comprises providing a respective at least one hysteretic pulse-width modulation (PWM) signal to the at least one power switch to control the repeated activation of the at least one power switch.

17. A power regulator system comprising:
means for repeatedly coupling an inductor to an input voltage to regulate a current flow through the inductor;
means for coupling and decoupling a light-emitting diode (LED) from the current flow through the inductor in response to an activation signal; and
means for dissipating the current flow through the inductor upon decoupling the LED from the current flow through the inductor.

18. The system of claim 17, wherein the means for dissipating provides a current path from an output of the inductor to the input voltage.

19. The system of claim 17, further comprising means for generating a hysteretic pulse-width modulation (PWM) signal to the means for repeatedly coupling.

20. The system of claim 19, further comprising means for generating a feedback voltage associated with a current flow through the LED to the means for generating the hysteretic PWM signal to regulate the current flow through the inductor.
